(19) United States
(12) Patent Application Publication
(10) Pub. No.: US 2014/0039251 A1
(43) Pub. Date: Feb. 6, 2014

(54) Method, system and device for automatic operating vibrator for sexual proposes

(71) Applicant: SHOHAM GOLAN, Natanya (IL)

(72) Inventor: SHOHAM GOLAN, Natanya (IL)

(21) Appl. No.: 13/563,186

(22) Filed: Jul. 31, 2012

(51) Int. Cl. A61H 19/00; A61H 1/00

(52) U.S. Cl. CPC A61H 19/44; A61H 1/00
USPC 600/38; 601/46

(57) ABSTRACT

Method, system and device for automatic operating vibrator for sexual proposes, wherein, the vibrator of the present invention designated to imitates male pin physiologic behaviors, furthermore, the vibrator designated to imitates automatically by the mechanism and the system of the present invention at list two shapes and condition, one vibrator position of “a fallen shape”, and the second is of “a stand still shape”, simulate the male pin erection, fitted to be implemented in a sexual uses, as in the method, system and device of the present invention.

### BACKGROUND OF THE INVENTION

The present invention relates to method, system and device for automatic operating vibrator for sexual proposes, and more particularly, related to vibrator for sexual proposes, designated to change the vibrator position and shape automatically, from “a fallen shape”, to “a stand still shape”, and from “a stand still shape” to “a fallen shape”, designated to simulate the human pin physiological behaviors automatically.

There is a growing acceptance of sexuality, as exhibited by popular acceptance of the near-universality of masturbation, and the growth of the market for sexual devices. Prior to this shift there have been a plethora of devices sold for sexual pleasure, although primarily under the euphemistic names and a pretense of providing “massage”. Modern sexual devices fall broadly into two classes: mechanized and no mechanized. Mechanized devices typically vibrate, although there are examples that rotate, thrust, and even circulate small beads within an elastomeric shell. Non-mechanized devices are made from a solid mass of rigid or semi-rigid material in a variety of shapes.

Although not spoken of openly in Western society until recently, oral sex is accorded a revered place in many cultures. Oral sex is the act of using the mouth, lips, and tongue to stimulate the female genitals. Oral sex is often accompanied by the insertion of fingers or a sexual aid into the vagina and/or into the anus, which allows for the simultaneous stimulation of the recipients sexual pleasure zones, which many women find can produce very intense sensations.

What is desirable is a method which can be performed in vibrator devices and systems, and which will enables the vibrator to imitates the male pin physiologic behaviors when come in contact with the female sexual area.

### SUMMARY OF THE INVENTION

It is to be understood that both the foregoing general description and the following detailed description present embodiments of the invention and are intended to provide an overview or framework for understanding the nature and character of the invention as it is claimed. The accompanying drawings are included to provide a further understanding of the invention and are incorporated into and constitute a part of this specification. The drawings illustrate various embodiments of the invention and, together with the description, serve to explain the principles and operations of the invention but not to limit the invention to these descriptions only.

Method, system and device for automatic operating vibrator for sexual proposes designated for a sexual stimulation aid, such as for a vibrator, wherein, the method enables the vibrator by its system and mechanism, enabling to simulate the male pin erection, the human male physiologic reaction of the male pin, wherein, such changes in the vibrator shape happened automatically, when the vibrator is coming in contact with the female sexual organ or body parts.

Wherein, the vibrator for sexual proposes, designated to change the vibrator position and shape automatically, from “a fallen shape”, to “a stand still shape”, simulating the male pin erection, and from “a stand still shape” to “a fallen shape”, designated to simulate the human pin physiological behaviors automatically.

wherein, the vibrator of the present invention include system and mechanism that enabling the vibrator to simulate the human male physiologic reaction of the male pin when the pin is coming in contact with the female sexual organ or other body parts.

One implementation of the vibrator of the present invention, include system and mechanism with an open electric circuit, wherein, when the front part of the vibrator, in the shape of the front part of the male pin, come in contact with the female body parts, it is pushes the front part of the vibrator to the back part of the vibrator, and both parts are closing an electric circuit, wherein, closing the electric circuit operate the system and mechanism of the vibrator designated automatically to change the vibrator shape from “a fallen shape”, to “a stand still shape” and optionally to enlarge the vibrator size.

Wherein, such operation of the vibrator automatically to change the vibrator shape, optionally include a second electric circuit with a timer, wherein, which enable the “ stand still shape” of the vibrator for a predetermine time, even if the first electric circuit that operate the system and the mechanism is open because of lack of contact with the female body for example, which open the first electric circuit between the vibrator front part and the vibrator back parts. Wherein, after the predetermine time of operation, the timer opens the second electric circuit, and the vibrator changes his shape again to its “default position”, to the “fallen shape”.

Wherein, the system and the mechanism enabling the vibrator of the present invention are optionally including, computerized or electronic parts, an electric power source, and system and mechanism of a telescopic section that enabling by its mechanism the enlargement, or the “erection” and the “fallen condition” of the vibrator in one implementation of the present invention, or in another implementation of the present invention, by air inflated mechanism, to stretch in some implementations of the present invention the outer cover parts and materials of the vibrator, such as silicon or rubber cover of the vibrator, or to shrunk, or to collapse them.

### BRIEF DESCRIPTION OF THE DRAWINGS

The accompanying drawings, which are incorporated in and form a part of this specification, illustrate embodiments of the invention and together with the description, serve to explain by way of example only, the principles of the invention:

FIG. 1 is a schematic perspective view of the vibrator, in his “cefault condition” of “fallen shape”, and the system and mechanism that operates it, as in the present invention;

FIG. 2 is another schematic implementation of perspective view of the vibrator device, system and mechanism of the present invention, showing the two conditions enabled in the present invention vibrator;

FIG. 3 is a schematic implementation perspective view of the vibrator device, and some implementation of system and mechanism that enabled the present invention the two conditions in the present invention vibrator;

### DESCRIPTION OF THE PREFERRED EMBODIMENTS

As will be appreciated the present invention is capable of other and different embodiments than those discussed above and described in more detail below, and its several details are capable of modifications in various aspects, all without departing from the spirit of the invention.

FIG. 1 is a schematic perspective view of the vibrator 100, in his “default condition” of “fallen shape”, and the system and mechanism that operates it automatically, as in the present invention; wherein, the method and system and the vibrator 100 enables the vibrator 100 by its system and mechanism, enabling to simulate the male pin erection, the human male physiologic reaction of the male pin, wherein, such changes in the vibrator shape happened automatically, when the vibrator is coming in contact with the female sexual organ or body parts.

Wherein, the vibrator for sexual proposes, designated to change the vibrator position and shape automatically, from “a fallen shape”, to “a stand still shape”, simulating the male pin erection, and from “a stand still shape” to “a fallen shape”, designated to simulate the human pin physiological behaviors automatically.

One implementation of the vibrator 100 of the present invention, include system and mechanism with an open electric circuit, wherein, when the front part 112 of the vibrator 100, in the shape of the front part of the male pin, come in contact with the female body parts, it is pushes the front part 112 of the vibrator to the back part 116 of the vibrator, and both parts 112 and 116 are closing an electric circuit, optionally the first electric circuit of the vibrator 100 system, wherein, closing the electric circuit operate the system and mechanism of the vibrator designated automatically to change the vibrator shape from “a fallen shape” as in the present view, to “a stand still shape” and optionally to enlarge the vibrator size.

Wherein, such operation of the vibrator automatically to change the vibrator shape, optionally include a second electric circuit with a timer, which enable the “stand still shape” of the vibrator for a predetermine time, even if the first electric circuit that operate the system and the mechanism is open because of lack of contact with the female body for example, the second electric circuit will still operate the vibrator 100 to the “stand still shape”. Wherein, after the predetermine time of operation, the timer opens the second electric circuit, and the vibrator 100 changes his shape again to its “default position”, to the “fallen shape”, as in the present view.

Wherein, the system and the mechanism enabling the vibrator of the present invention are optionally including, computerized or electronic parts, an electric power source and system and mechanism to enable the changes in the vibrator 100 shapes, some located in section 102 of the vibrator 100. Wherein, the system and mechanism enable the changes in the vibrator 100 shapes, that enabling by its mechanism the enlargement, or the “erection” and the “fallen condition” of the vibrator 100 in one implementation of the present invention, is by air inflated mechanism, located for example in back section 102, and pushing and inflating by air through piping 104 and 106 the hollowed section 108 of the vibrator, to stretch in some implementations of the present invention the outer cover parts and materials 110 of the vibrator, such as the silicon or the rubber cover 110 of the vibrator 100, or to shrunk, or to collapse them.

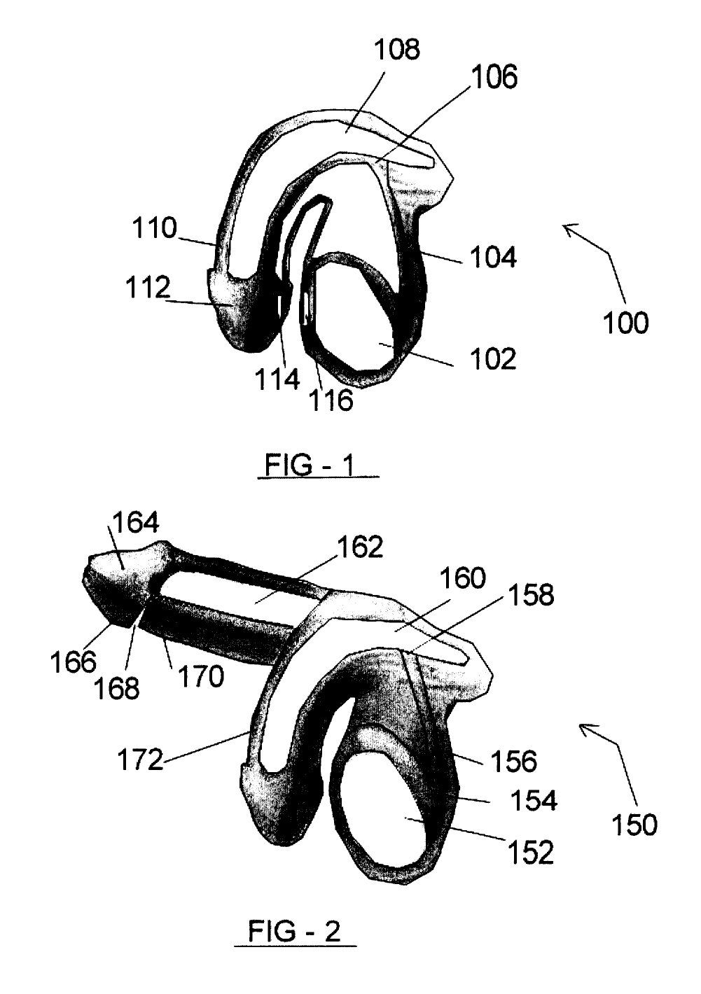

FIG. 2 is another schematic implementation of perspective view of the vibrator 150 device, system and mechanism of the present invention, showing by simulation the two conditions enabled in the present invention vibrator 150 (just for a better understanding, because the vibrator of the present invention cannot be in both condition in the same time, just one condition an shape at a time), the enlargement and the “erection condition” 164, and the “fallen condition” 172 of the vibrator 150. Wherein, some parts and mechanism and power source are located in one implementation of the present invention in section 152 of the vibrator 150, and has some extension passes through piping 154, 156 and 158, to the hollowed section 160 of the vibrator 150, wherein, when the mechanism is automatically operates and inflating air into hollow section 160 which changes shape when section 162 is full with enough air presser, as in one implementation of the present invention, the default shape 172, the “fallen shape”, of the vibrator 150, changes to the second shape of a “stand still shape” 164, simulate the male pin erection, fitted to be implemented in a sexual uses, as in the method, system and device of the present invention. Wherein, such change in shapes enabled because the flexible material of the outer cover 170 and 172 of the vibrator 150. Furthermore, gap 168 showing another optional implementation to operates the vibrator 150 automatically, this by closing the gap 168 that causes the first electric circuit to be opened, this by outer contact that pushes section 166 to section 170, closing the gap 168 and closing the first electric circuit that operates the second electric circuit that activate the mechanism of vibrator 150, another optional implementation may act in a reverse action, such if the gap 168 is opened for predetermine time period, the system of the vibrator 150 will be closed and the vibrator will be returned to its default shape 172.

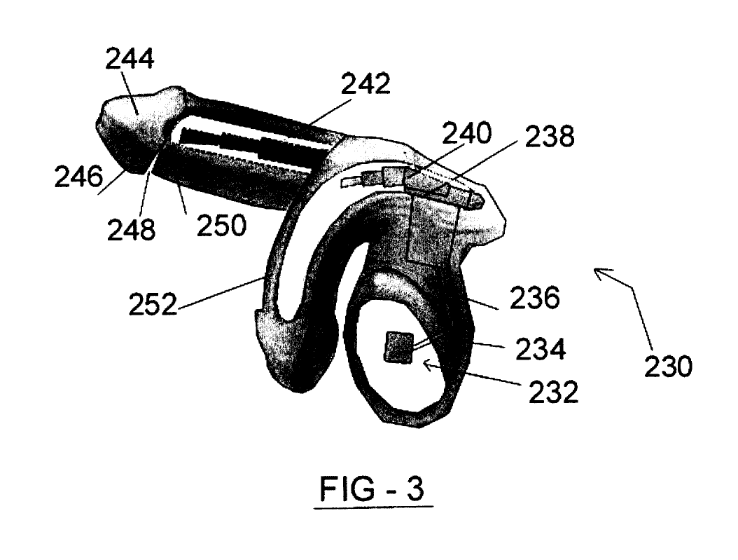

FIG. 3 is a schematic implementation perspective view of the vibrator 230 device, and some implementation of system and mechanism that enabled the present invention the two conditions in the present invention vibrator, Wherein, the system and the mechanism enabling the vibrator of the present invention are optionally including, computerized or electronic parts, an electric power source and system and mechanism to enable the changes in the vibrator 230 shapes, some located in section 232 of the vibrator 230. Wherein, the system and mechanism enable the changes in the vibrator 230 shapes, that enabling by its mechanism, mechanism of a telescopic sections 238 and 240 with connections 236 and 234 to power source 232, the enlargement, or the “erection” shape 244 when the telescopic sections 242 wide open, and the “fallen condition” 252 when the telescopic sections 240 is closed, in one implementation of the present invention. Wherein, gap 248 showing another optional implementation to operates the vibrator 230 automatically, this by closing the gap 248 that causes the first electric circuit to be opened, this by outer contact that pushes section 246 to section 250, closing the gap 248 and closing the first electric circuit that operates the second electric circuit that activate the mechanism of vibrator 230.

1. A method for a vibrator used for sexual stimulation, wherein, the method comprising:
a. A vibrator designated for a sexual stimulation aid, wherein, the vibrator by its system and mechanism, designated to simulate the human male physiologic reaction of the male sexual pin when coming in contact with the female sexual organs, and stimulates, and as a results of this to change its shape automatically, from “fallen condition”, a “non-stimulation condition”, to “erection condition”, optionally make it grow in size to a bigger size then in the non-stimulation condition, wherein;
b. the method enabled to change the vibrator shape automatically, by mechanism and system that fitted to operate in time of stimulation, wherein;
c. at list part of the vibrator sections are hollowed, to accommodate and enabled at list some of the mechanism and the system of the vibrator that responsible to shift automatically between the vibrator two shapes, wherein;
d. at list part of the outer sections of the vibrator are from flexible materials, such as silicon and rubber, to enabled the changes between the loosen shape and the erect shape of the vibrator, wherein;
e. automatic change of the vibrator shape enabled by variety of optional mechanism, such as: an inflatable mechanism that inflates and fill air to some of the vibrator hollow sections, and in the second shape sucks the air out from the vibrator; or by a mechanical mechanism such as a telescopic section that located in some of the vibrator hollow parts, with characteristics that enabling the telescopic section lengthens and shortened respectively.

2. method as in claim 1, wherein such automatic changes between the two shapes enabled in the present vibrator, and such automatic operation of the mechanism responsible to make those shape changes, are operated to and on, or off condition, by the first open electric circuit of the vibrator, which is in this state in the vibrator “default condition”, the “loose shape”, wherein, a contact and some pressure between the vibrator and outer parts, such as the female body parts, closes this first electric circuit, and operates the vibrator mechanism, optionally, some sensors can be a substitute to the first electric circuit, or an on/off button.

3. Method as in claim 2, wherein the first electric circuit operates a second electric circuit that operates the mechanism of the vibrator.

4. Method as in claim 2, wherein the second electric circuit has a timer that enabled the electric circuit to be closed and to operates the mechanism to the predetermine time that determined to the timer, even if the first electric circuit is opened again.

5. Method as in claims 1, 2, 3 and 4, wherein such vibrator has an additional vibrator connected or part of it.

6. Method as in claim 5, wherein such vibrator has an additional parts enabled to connect it to the user body, such as bands.

7. Method as in claim 5, wherein such vibrator is part of a sexual simulation doll.

8. A vibrator used for sexual stimulation, wherein, the vibrator comprising:
a. A vibrator designated for a sexual stimulation aid, wherein, the vibrator by its system and mechanism, designated to simulate the human male physiologic reaction of the male sexual pin when coming in contact with the female sexual organs, and stimulates, and as a results of this to change its shape automatically, from “fallen condition”, a “non-stimulation condition”, to “erection condition”, optionally make it grow in size to a bigger size then in the non-stimulation condition, wherein;
b. the vibrator enabled to change the vibrator shape automatically, by mechanism and system that fitted to operate in time of stimulation, wherein;
c. at list part of the vibrator sections are hollowed, to accommodate and enabled at list some of the mechanism and the system of the vibrator that responsible to shift automatically between the vibrator two shapes, wherein;
d. at list part of the outer sections of the vibrator are from flexible materials, such as silicon and rubber, to enabled the changes between the loosen shape and the erect shape of the vibrator, wherein;
e. automatic change of the vibrator shape enabled by variety of optional mechanism, such as: an inflatable mechanism that inflates and fill air to some of the vibrator hollow sections, and in the second shape sucks the air out from the vibrator; or by a mechanical mechanism such as a telescopic section that located in some of the vibrator hollow parts, with characteristics that enabling the telescopic section lengthens and shortened respectively.

9. vibrator as in claim 8, wherein such automatic changes between the two shapes enabled in the present vibrator, and such automatic operation of the mechanism responsible to make those shape changes, are operated to and on, or off condition, by the first open electric circuit of the vibrator, which is in this state in the vibrator “default condition”, the “loose shape”, wherein, a contact and some pressure between the vibrator and outer parts, such as the female body parts, closes this first electric circuit, and operates the vibrator mechanism, optionally, some sensors can be a substitute to the first electric circuit, or an on/off button.

10. Vibrator as in claim 9, wherein the first electric circuit operates a second electric circuit that operates the mechanism of the vibrator.

11. vibrator as in claim 9, wherein the second electric circuit has a timer that enabled the electric circuit to be closed and to operates the mechanism to the predetermine time that determined to the timer, even if the first electric circuit is opened again.

12. Vibrator as in claims 8, 9, 10 and 11, wherein such vibrator has an additional vibrator connected or part of it.

13. Vibrator as in claim 12, wherein such vibrator has an additional parts enabled to connect it to the user body, such as bands.

14. Vibrator as in claim 12, wherein such vibrator is part of a sexual simulation doll.
